(19) United States
(12) Patent Application Publication
(10) Pub. No.: US 2026/0195912 A1
(43) Pub. Date: Jul. 9, 2026

(54) IMAGE PROCESSING METHOD AND METHOD FOR PREDICTING COLLISIONS

(71) Applicant: Continental Autonomous Mobility Germany GmbH, Ingolstadt (DE)

(72) Inventors: Srividhya Kannan, Chennai (IN); Ramalingam Dharmalingam, Dharmapuri (IN); Sheha K. Hegde, Karkala (IN); Tejas Tanksale, Pune (IN); Abhishek Vashisht, Mumbai (IN); Stefan Heinrich, Achern (DE)

(73) Assignee: Continental Autonomous Mobility Germany GmbH, Ingolstadt (DE)

(21) Appl. No.: 19/128,210

(22) PCT Filed: Oct. 26, 2023
(86) PCT No.: PCT/EP2023/079921

§ 371 Date: May 8, 2025

(30) Foreign Application Priority Data
Nov. 11, 2022 (IN) 202241064626
Apr. 17, 2023 (GB) 2305580.9

(51) Int. Cl. G06T 7/593; G06T 7/11; G06V 10/26; G06V 10/75; G06V 10/82; G06V 20/58

(52) U.S. Cl. CPC G06T 7/593; G06T 7/11; G06V 10/26; G06V 10/751; G06V 10/82; G06V 20/58; G06T 2207/10012; G06T 2207/10028; G06T 2207/20081; G06T 2207/20084; G06T 2207/30261

(57) ABSTRACT

A computer-implemented image processing method may include inputting a stereo image set to a machine learning model. The stereo image set may include a first image and a second image. The method may further include generating a rotated disparity map of the stereo image set, using the machine learning model. The method may further include, for each pixel in the first image—identifying a corresponding pixel in the second image based on the rotated disparity map, determining a respective rotation angle between the pixel in the first image and the corresponding pixel in the second image relative to a common image center, and determining a respective unrotated disparity based on the respective rotation angle. The method may further include generating a unrotated disparity map based on the respective unrotated disparities of each pixel in the first image.

### TECHNICAL FIELD

Various embodiments relate to methods and devices for processing stereo images, methods and devices for predicting collisions and methods for training a machine learning model.

### BACKGROUND

Stereovision techniques typically use two cameras to look at the same object. The two cameras may be separated by a baseline distance. The baseline distance is assumed to be known accurately. The two cameras may simultaneously capture two images, also referred to as stereo images. The stereo images may be analyzed to identify the differences between the two images. The differences between the two images may be referred to as disparity. The disparity between the two images may be used to determine depth of a point in the images. The depth information may be used to project the point in a three-dimensional model. Such three-dimensional (3D) models may be useful for facilitating various driver assistance or autonomous driving functions. For example, the three-dimensional model may provide information on positions of various objects near to a vehicle, thereby aiding navigation or obstacle avoidance.

For automobile applications, the stereo cameras may be installed onto a vehicle to capture images of the surroundings of the vehicle. The stereo cameras need to be precisely calibrated in order for the disparity acquired from the images to be accurate. However, regular movements of the vehicle, for example, over a pothole on the road, or over a road hump, may result in vibrations that displace the stereo cameras, thereby decalibrating the stereo cameras. When this happens, the stereo images cannot be relied on to generate accurate depth information that is needed for the three-dimensional model. Consequently, the three-dimensional model would not be suitable for use as a means to detect objects present in the vehicle's surroundings, or to prevent collisions with the objects.

### SUMMARY

According to various embodiments, there is provided a computer-implemented image processing method. The image processing method may include inputting an image set to a machine learning model. The image set may include a first image and a second image. The image processing method may further include generating a rotated disparity map of the image set, using the trained machine learning model. The image processing method may further include, for each pixel in the first image-determining, based on the rotated disparity map, a rotation angle between the pixel in the first image and its corresponding position in the second image, relative to a common image center, and determining a respective unrotated disparity based on the respective rotation angle. The image processing method may further include generating an unrotated disparity map based on the respective unrotated disparity of each pixel in the first image.

According to various embodiments, there is a provided an image processing device that includes a processor. The processor may be configured to perform the abovementioned image processing method.

According to various embodiments, there is provided a computer-implemented method for predicting collisions. The method may include inputting a sequence of image sets to a motion detection model. Each image set of the sequence may include a first image and a second image. The method may further include determining by the motion detection model, for each image set, a respective depth map based on the first image and the second image of the stereo image set, resulting in a sequence of depth maps. The method may further include determining by the motion detection model, an optical flow based on at least one of, the first images from the sequence of image sets and the second images of the sequence of stereo image sets. The method may further include determining by the motion detection model, motion of an object in the image set based on the optical flow. The method may further include determining time-to-collision with the object based on the sequence of depth maps and the determined motion of the object.

According to various embodiments, there is a provided a device for predicting collisions. The device may include a processor configured to perform the abovementioned method for predicting collisions.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the embodiments. In the following description, various embodiments are described with reference to the following drawings, in which:

FIG. 1 shows a block diagram of a computer-implemented method of training a machine learning model to determine disparity of images, according to various embodiments.

FIG. 2 shows a block diagram of a computer-implemented method of generating a 3D model using stereo images, according to various embodiments.

FIG. 3 shows an example of an image set according to various embodiments.

FIG. 4 shows an example of how a position of a feature point may differ in the left image and the right image.

FIG. 5A shows an example of an image set according to various embodiments.

FIG. 5B shows disparity images generated by a prior art machine learning model and the trained machine learning model according to various embodiments.

FIG. 6 shows an image processing method according to various embodiments.

FIG. 7A shows a simplified block diagram of an image processing device according to various embodiments.

FIG. 7B illustrates an operation of the image processing device according to various embodiments.

FIG. 8A shows a simplified functional block diagram of a device for predicting collisions according to various embodiments.

FIG. 8B shows a simplified hardware block diagram of the device according to various embodiments.

FIG. 9 shows a schematic diagram of the device performing a method for predicting collisions, according to various embodiments.

FIG. 10 shows a schematic diagram of a neural network according to various embodiments.

FIG. 11 shows a schematic diagram of the neural network according to various embodiments, receiving different inputs from those in FIG. 10.

FIG. 12 shows a flow diagram of a computer-implemented method for predicting collisions, according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the features may be readily understood and put into practical effect, various embodiments will now be described by way of examples and not limitations, and with reference to the figures.

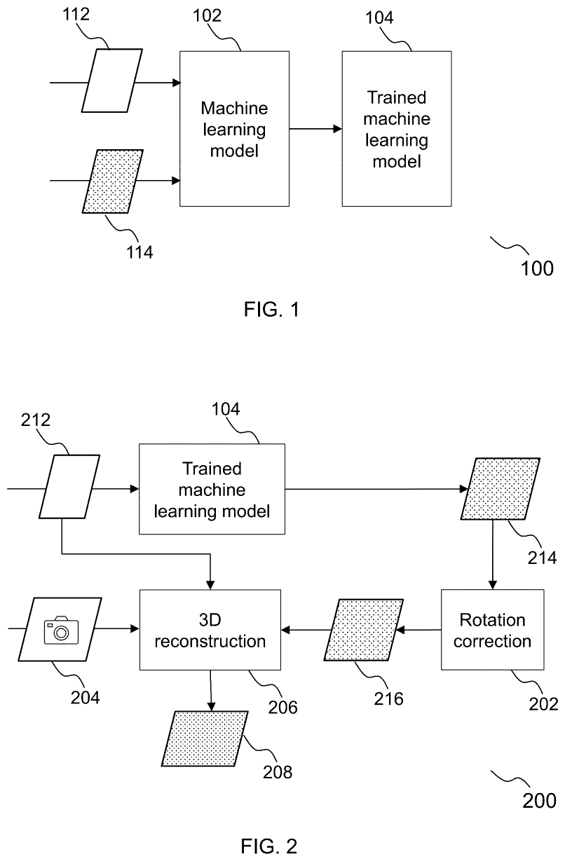

FIG. 1 shows a block diagram of a computer-implemented method 100 of training a machine learning model 102 to determine disparity of images, according to various embodiments. The method of training the machine learning model 102 may include providing training image data 112 to the machine learning model 102. The training image data 112 may include left stereo images and right stereo images from uncalibrated stereo cameras. In other words, the training image data 112 may include uncalibrated stereo images. Ground truth disparity data 114 that corresponds to each set pair of left and right stereo images of the training image data 112 may also be provided to the machine learning model 102 as a training signal. The machine learning model 102 may be configured to extract features from the training image data 112, and may learn a pattern between the extracted features and the ground truth disparity data 114. As a result of training using the training image data 112 and the ground truth disparity data 114, the machine learning model 102 learns to compute a disparity map for each pair of left and right stereo image pair. The resulting machine learning model is referred herein as the trained machine learning model 104. The trained machine learning model 104 may include a neural network 1000 that will be described further with respect to FIG. 10.

In a general stereo camera set up, a feature point of the left stereo image and the corresponding feature point of the right stereo image are aligned on the same x-axis, also referred to as horizontal axis. Due to vibration or mechanical set up, one of the stereo cameras may be misaligned with the other stereo camera with at least one of the following factors: roll, i.e. rotation angle (α), pitch, yaw, and translation (xₜ, yₜ) where xₜ refers to movement of an image pixel along the horizontal axis and yₜ refer to movement of the image pixel along the vertical axis. The trained machine learning model 104 may be configured to determine rotated disparities for the above-mentioned misalignments, as the training image data 112 includes uncalibrated stereo images. The method 100 may further include rotating stereo images to artificially uncalibrate the training image data 112.

According to an embodiment which may be combined with any above-described embodiment or with any below described further embodiment, the training image data 112 may include images obtained from a plurality of cameras that may not be stereo cameras. These images may capture a similar scene from different angles, and hence, may similarly be used to determine depth of objects in the scene, like stereo images.

According to an embodiment which may be combined with any above-described embodiment or with any below described further embodiment, the cameras or stereo cameras that capture the training image data 112 may be coupled to a vehicle. The training image data 112 may capture scenes around the vehicle.

According to an embodiment which may be combined with any above-described embodiment or with any below described further embodiment, the method 100 may further include classifying the disparity range into near range and far range while training the machine learning model 102. For example, the ground truth disparity data 114 may be split into a near range ground truth disparity data and a far range ground truth disparity data. The machine learning model 102 may be trained to compute near range ground truth disparity using the near range ground truth disparity data as the training signal. The machine learning model 102 may be further trained to compute far range ground truth disparity using the far range ground truth disparity data as the training signal, in a separate process from the training using near range ground truth disparity. By training the machine learning model 102 for near range and far range disparities separately, the accuracy of the trained machine learning model 104 may be improved. The time taken to train the machine learning model 102 may also be reduced.

FIG. 2 shows a block diagram of a computer-implemented method 200 of generating a 3D model using stereo images, according to various embodiments. The method 200 may include providing image data to the trained machine learning model 104. The image data may include an image set 212. The image set 212 may include a left stereo image and a right stereo image. The trained machine learning model 104 may extract feature information from the left and right stereo images, and may generate a rotated disparity map 214 based on the extracted feature information. A rotation correction module 202 may receive the rotated disparity map 214 and correct the rotated disparity map 214 for the relative rotation between the images in the image set 212. The rotation correction module 202 may generate a unrotated disparity map 216 based on the rotated disparity map 214. The rotation correction module 202 may provide the unrotated disparity map 216 to a 3D reconstruction module 206. The 3D reconstruction module 206 may generate a 3D point cloud 208 based on the unrotated disparity map 216, camera parameters 204 and the image set 212. The rotated disparity map 214 may include the actual disparities of every pixel between the uncalibrated left and right stereo images. The unrotated disparity map 214 may include corrected disparities of every pixel between the uncalibrated left and right stereo images, as if the misaligned stereo image was already corrected back to its calibrated position.

The method 200 may be able to generate 3D point clouds with depth measurements that are more accurate, and at a lower cost, as compared to LiDAR sensors. The method 200 may also be able to determine the depth in scenes captured on the images regardless of dynamic decalibrations of the cameras, including rotation, horizontal shift and vertical shift. The method 200 may also be able to generate the 3D point clouds even if the image set 212 includes distorted images and modified intrinsics, and if the camera parameters are inaccurate, for example, incorrect focal lens information.

According to an embodiment which may be combined with any above-described embodiment or with any below described further embodiment, the image set 212 may include images obtained from a plurality of cameras that may not be stereo cameras. These images may capture a similar scene from different angles, and hence, may similarly be used to determine depth of objects in the scene, like stereo images.

According to an embodiment which may be combined with any above-described embodiment or with any below described further embodiment, the cameras or stereo cameras that capture the image set 212 may be coupled to a vehicle. The image set 212 may capture scenes around the vehicle.

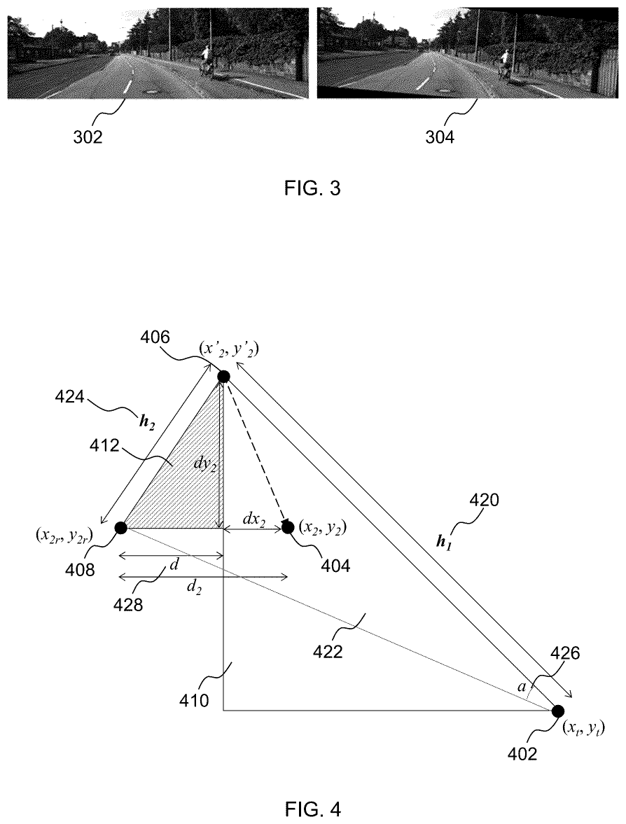

FIG. 3 shows an example of an image set 212 according to various embodiments. The image set 212 may include a left image 302 and a right image 304. The image set 212 may be uncalibrated. The right image 304 is rotated relative to the left image 302. This can happen, when at least one of the stereo cameras is not installed properly, or is displaced from its original position. For example, when the vehicle drives over a road hump or makes a sharp movement, the stereo camera may experience vibration that results in a slight displacement. The rotation correction module 202 may determine the unrotated disparity map 216 based on the rotated disparity map 214, such that the unrotated disparity map 216 provides information on the displacement between each pixel in the left image 302 and its corresponding right image 304 as if the left image 302 and the right image 304 are aligned on a horizontal axis. The process of determining the unrotated disparity map 216 is described with respect to FIG. 4.

FIG. 4 shows an example of how a position of a feature point may differ in the left image 302 and the right image 304. In this example, an image center 402 may be considered to be (0,0). A feature point 404 of the left image 302 is denoted as (x₂, y₂). The corresponding position 406 of the feature point 404 in the right image 304 as rotated, is denoted as (x′₂, y′₂). A line connecting the corresponding position 406 and the image center 402 may define a first hypotenuse 420, indicated herein as “h₁”, of a right angle triangle 410. The corresponding position 406 of the feature point 404 in the right image 304 may be determined based on the rotated disparity map 214.

The rotated disparity map may include rotated disparity values (dx₂, dy₂) for the feature point 404. The corresponding position 406, and the first hypothenuse 420, may be determined based on the feature point 404 and the rotated disparity values according to the following equations (1) to (3).

$${x}_{2}^{′} = {x}_{2} + {dx}_{2} \qquad Equation ( 1 )$$

$${y}_{2}^{′} = {y}_{2} + d {y}_{2} \qquad Equation ( 2 )$$

$${h}_{1} = \sqrt{( {x}_{2}^{′2} + {y}_{2}^{′2} )} \qquad Equation ( 3 )$$

The unrotated disparity values of the feature point 404 may be expressed as (dx₂, dy₂). The unrotated corresponding position 408 of the feature point 404 in the right image 304 when the right image 304 is adjusted to have zero rotation angle relative to the left image 302, is denoted as (x₂ᵣ, y₂ᵣ).

The corresponding position 406, the unrotated corresponding position 408 and the image center 402 may define vertices of an isosceles triangle 422. The distance between the corresponding position 406 and the image center 402 may be at least substantially equal to the distance between the unrotated corresponding position 408 and the image center 402, in other words, equal to the first hypotenuse 420. The vertex angle 426 of the isosceles triangle 422 is denoted as a. The vertex angle 426 may also be referred herein as rotation angle 426.

A line connecting the corresponding position 406 and the unrotated corresponding position 408, may define a second hypotenuse 424, denoted herein as “h₂”, of another right angle triangle 412. The second hypotenuse 424 may be the base of the isosceles triangle 422. The second hypotenuse 424 may be determined according to equation (4).

$${h}_{2} = 2 \times {h}_{1} \times sin \frac{a}{2} \qquad Equation ( 4 )$$

The base 428 of the other right angle triangle 412 is denoted as d. The length of the base 428 may be determined according to the equation (5).

$$d = \sqrt{{( {h}_{2}^{2} - d {y}_{2}^{2} )}_{}} . \qquad Equation ( 5 )$$

The unrotated disparity value d₂ may be determined based on the base 428 and the rotated disparity value dx₂. The unrotated disparity value may be determined according to the following equation (6).

$${d}_{2} = d + d {x}_{2} \qquad Equation ( 6 )$$

The rotation correction module 202 may determine the unrotated disparity map 216 based on the abovementioned computations. The rotation correction module 202 may determine the corresponding position 406 based on the rotated disparity values in the rotated disparity map 214. The rotation correction module 202 may determine the first hypothenuse 420 based on the corresponding position 406. The rotation correction module 202 may determine the vertex angle 426. Determining the vertex angle 426 may include determining direction of epipolar lines of the image set 212, in the image plane without using 3D space. The vertex angle 426 may then be obtained by projecting the rotated disparity measurements towards the epipolar line directions. The rotation correction module 202 may determine the second hypotenuse 424 based on the vertex angle 426 and the first hypotenuse 420. The rotation correction module 202 may determine the base 428 based on the second hypotenuse 424 and the rotated disparity values. The rotation correction module 202 may determine the unrotated disparity value based on the base 428 and the rotated disparity values.

According to an embodiment which may be combined with any above-described embodiment or with any below described further embodiment, the rotation correction module 202 may be configured to determine direction of epipolar lines of the image set 212, in the image plane without using 3D space. The rotation correction module 202 may determine the epipolar line directions without prior knowledge about the intrinsic and extrinsic camera parameters. The rotation correction module 202 may determine the epipolar line directions, by processing the images in the image set 212, region by region. In other words, the images may be segmented into a plurality of regions, and the epipolar line directions may be determined in each region of the plurality of regions.

The rotation correction module 202 may be configured to check for infinity-negative disparities in the vertical disparity. The real distance represented in the images may be computed by the projection of the disparities through the epipolar line direction. The real distances may be determined region by region, in other words, determined in each region of the plurality of regions.

According to an embodiment which may be combined with any above-described embodiment or with any below described further embodiment, the rotation correction module 202 be further configured to determine the translation (xₜ, yₜ) and further configured to correct the right image with respect to the left image, based on the determined translation. The horizontal translation x, may be computed using tracking and filtering of the input images over time. The vertical translation yₜ may be determined based on the pixel information in the centre of y-disparity in a y-disparity array.

According to an embodiment which may be combined with any above-described embodiment or with any below described further embodiment, the 3D reconstruction module 206 may be configured to generate an unscaled 3D point cloud based on the unrotated disparity map 216. The trained machine learning model 104 may receive a sequence of image sets 212 over time, and thereby generating a sequence of rotated disparity maps 214. Accordingly, the rotation correction module 202 may generate a sequence of unrotated disparity maps. The 3D reconstruction module 206 may correct the 3D point cloud for camera factors such as scale and yaw angle, based on comparing at least two consecutive 3D point clouds. Points in the 3D point cloud should move at least substantially at the same velocity, as the points move relative to the vehicle that the cameras are coupled to. In other words, the points in the 3D point cloud may move at a velocity that is at least substantially equal to the longitudinal speed of the vehicle. The 3D reconstruction module 206 may correct the 3D point cloud for camera factors based on velocity deviations of points in the 3D point cloud.

According to an embodiment which may be combined with any above-described embodiment or with any below described further embodiment, the method 200 may further include correcting for negative disparities in the image set 212. The correction for negative disparities may be performed before performing 3D reconstruction. The negative disparities may be caused by yaw angle errors between the cameras that captured the image set 212. A change in the yaw angle of at least one camera may result in a horizontal shift. In stereo images, the horizontal disparity decreases as distance, i.e. depth, increases. As such, the horizontal disparity of objects in infinity, also referred herein as infinity objects, should be at least substantially zero. However, the infinity objects may display negative horizontal disparities instead of zero disparity when there is a negative yaw angle between the cameras. The method 200 may further include applying a low pass filter to the unrotated disparity map 216, to obtain the maximum negative disparity values, i.e. the negative disparity values with the largest amplitude, in the unrotated disparity map 216. The method 200 may include using the maximum negative disparity value to correct the disparities in the entire image region. Correction of the disparities may be performed region by region, where each image may be divided into a plurality of regions.

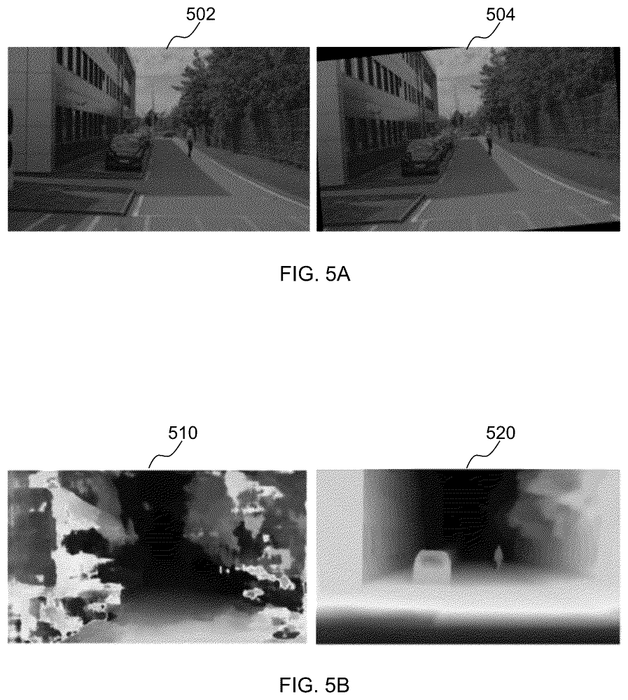

FIG. 5A shows an example of an image set 212 according to various embodiments. In this example, the image set 212 includes a first image 502 and a second image 504. The first image 502 was taken by a first camera while the second image 504 was taken by a second camera. Both the first camera and the second camera captured images of the same scene, from slightly offset positions. In other words, the second camera is positioned at a calibrated distance away from the first camera. In a scenario when the second camera is decalibrated in terms of rotation, the second image 504 is rotated relative to the first image 502.

FIG. 5B shows disparity images generated by a prior art machine learning model and the trained machine learning model 104 according to various embodiments. The disparity images include a first disparity image 510 and a second disparity image 520, which were both generated by machine learning models based on the example image set 212 of FIG. 5A. The first disparity image 510 was generated by a prior art machine learning model. The prior art machine learning model failed to handle the decalibration of the second image 504, and as such, objects in the image set 212 are not visible in the first disparity image 510. In contrast, the second disparity image 520 clearly shows the objects in the image set 212, which indicates that the trained machine learning model 104 was able to correctly match features between the first image 502 and the second image 504 in spite of the decalibration of the second image 504.

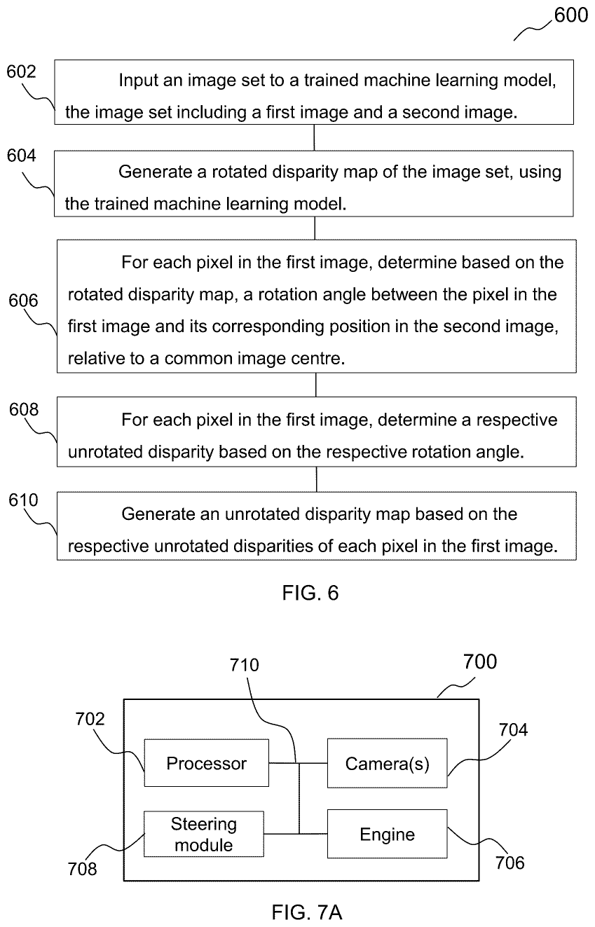

FIG. 6 shows an image processing method 600 according to various embodiments. The image processing method 600 may include processes 602, 604, 606, 608 and 610. The process 602 may include inputting an image set 212 to a trained machine learning model 104. The image set 212 may include a first image and a second image. The process 604 may include generating a rotated disparity map 214 of the image set 212, using the trained machine learning model 104. The process 606 may include, for each pixel in the first image, determining based on the rotated disparity map 214, a rotation angle between the pixel in the first image and its corresponding position in the second image, relative to a common image center. The process 608 may include, for each pixel in the first image, determining a respective unrotated disparity based on the respective rotation angle. The process 610 may include generating unrotated disparity map 216 based on the respective unrotated disparities of each pixel in the first image. The image processing method 600 may determine an unrotated disparity map that may be used to accurately determine depth of points in the image set 212, for example, to construct an accurate 3D point cloud, without having to calibrate the cameras that capture the image set 212. These cameras may be mounted on a vehicle, to capture the surroundings of the vehicle. Cameras mounted on the vehicle may shift out of their initial calibrated positions due to vibrations or movements of the vehicle. Using the image processing method 600, the depth of points in the image set 212 may be determined accurately without being affected by the decalibration of the cameras.

According to an embodiment which may be combined with any above-described embodiment or with any below described further embodiment, the image set 212 may include stereo images. The first image may be a left stereo image, while the second image may be a right stereo image. A stereo image set may capture a similar scene from slightly different positions, such that the images within the stereo image set may be compared to obtain depth information on each point in the images. This depth information may be useful for providing situational awareness to a vehicle, such as indicating the vehicle's distances to various objects in its surroundings.

According to an embodiment which may be combined with any above-described embodiment or with any below described further embodiment, the trained machine learning model 104 may be configured to determine both horizontal disparities and vertical disparities of the image set 212, such that the rotated disparity map 214 may include both horizontal disparities and vertical disparity values of the image set. By determining both horizontal disparities and vertical disparities of the image set 212, the trained machine learning model 104 may be capable of handling decalibration of the cameras in both vertical and horizontal directions. As such, the image processing method 600 may result in an accurate disparity map even if at least one of the cameras is shifted out of place in both directions, or is rotated.

According to an embodiment which may be combined with any above-described embodiment or with any below described further embodiment, the common image center may be an arbitrary point in the image and may be close to the image center of at least one of the first image and the second image.

According to an embodiment which may be combined with any above-described embodiment or with any below described further embodiment, a center of the first image may be used as the common image center. The first image may be used as a reference image, and the translation of the second image relative to the first image may be estimated.

According to an embodiment which may be combined with any above-described embodiment or with any below described further embodiment, the image processing method 600 may further include segmenting the first image into a plurality of first regions, and segmenting the second image into a plurality of second regions corresponding to the plurality of first regions. The image processing method 600 may further include determining an epipolar line and its direction based on a pixel in the first image and its corresponding position in the second image, for each first region of the plurality of first regions.

According to an embodiment which may be combined with any above-described embodiment or with any below described further embodiment, the image processing method 600 may further include for each pixel of the first image, determining a respective horizontal disparity based on projection of the respective unrotated disparity through the direction of the epipolar line. The horizontal disparity in the image set 212, for example, caused by misalignment of at least one camera, may be thereby corrected.

According to an embodiment which may be combined with any above-described embodiment or with any below described further embodiment, the image processing method 600 may further include generating a 3D point cloud 208 based on the image set 212 and further based on the unrotated disparity map 216. The 3D point cloud may provide detailed information about the surroundings of a vehicle, and may serve to aid the vehicle in various functions such as navigation, localization and avoidance of obstacles.

According to an embodiment which may be combined with any above-described embodiment or with any below described further embodiment, the image processing method 600 may further include inputting a further image set to the trained machine learning model 104. The further image set may include a further first image and a further second image captured at a consecutive time frame from the first image and the second image of the image set 212. The image processing method 600 may further include generating a further rotated disparity map of the further image set, using the trained machine learning model 104. The image processing method 600 may further include, for each pixel in the further first image, identifying a corresponding pixel in the further second image based on the further rotated disparity map, determining a respective rotation angle between the pixel in the further first image and the corresponding pixel in the further second image, relative to a further common image center, and determining a respective unrotated disparity based on the respective rotation angle. The image processing method 600 may further include generating a further unrotated disparity map based on the respective unrotated disparities of each pixel in the further first image. The image processing method 600 may further include generating a further 3D point cloud based on the further image set and further based on the further unrotated disparity map, determining a distance that each point in the 3D point cloud moves from the 3D point cloud 208 to the further 3D point cloud, and correcting at least one of the 3D point cloud 208 and the further 3D point cloud, based on the determined distances. The 3D reconstruction module 206 may perform the above-described correction of the 3D point cloud 208 or the further 3D point cloud. Points in the 3D point cloud should move at least substantially at the same velocity, as the points move relative to the vehicle that the cameras are coupled to. The 3D reconstruction module 206 may correct the 3D point cloud for camera factors such as scale and yaw angle, based on velocity deviations of points in the 3D point cloud.

According to an embodiment which may be combined with any above-described embodiment or with any below described further embodiment, the trained machine learning model 104 may be trained using a training dataset 112 that includes a plurality of image pairs generated by rotating a pair of calibrated images to a corresponding plurality of different angles, and using a ground truth disparity map 114 generated based on the pair of calibrated images as a training signal. As the training dataset 112 is generated using calibrated images, a precise ground truth disparity map 114 may be obtained.

According to an embodiment which may be combined with any above-described embodiment or with any below described further embodiment, the trained machine learning model 104 may be trained to determine near range disparities, and further separately trained to determine far range disparities. Doing so may optimize the training process, reducing the training time required and improving the accuracy of the trained machine learning model 104 in determining the disparities.

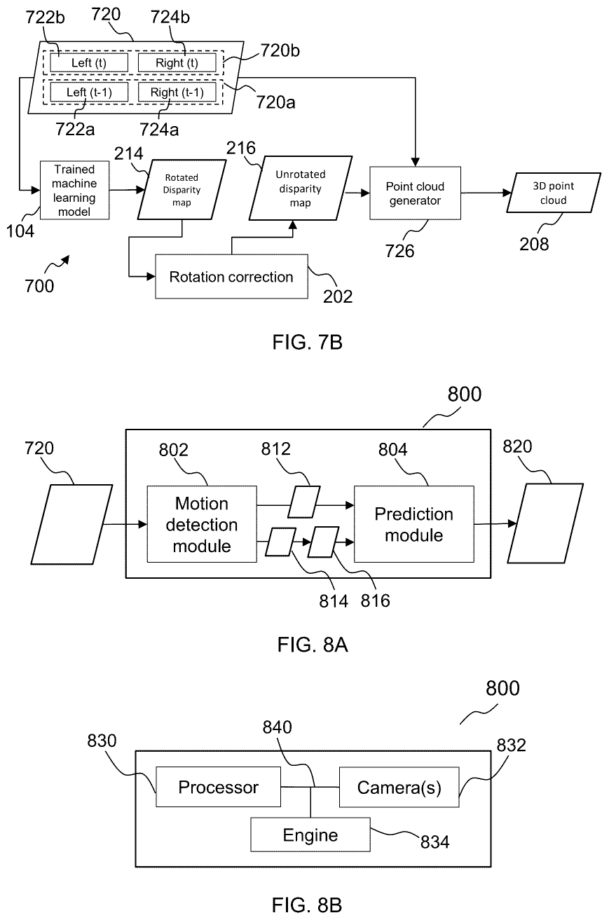

FIG. 7A shows a simplified block diagram of an image processing device 700 according to various embodiments. The image processing device 700 may include a processor 702. The processor 702 may be configured to perform the image processing method 600.

According to an embodiment which may be combined with any above-described embodiment or with any below described further embodiment, the image processing device 700 may be any one of a server, a computer, a vehicle or a robot. The image processing device 700 may be an autonomous vehicle, such as a self-driving car, or a drone.

According to an embodiment which may be combined with any above-described embodiment or with any below described further embodiment, the image processing device 700 may further include at least one camera 704. The camera 704 may be configured to capture the image set 212. The image processing device 700 may further include an engine 706 configured to drive the image processing device 700. The image processing device 700 may further include a steering module 708 configured to steer the image processing device 700.

FIG. 7B illustrates an operation of the image processing device 700 according to various embodiments. The input 720 to the image processing device 700 may include a sequence of image sets. The sequence of image sets may include consecutively captured images. For example, the sequence of image sets may include an image set 720a captured at t−1, and another image set 720b captured at t, where t denotes time as a variable. In other words, the image set 720b may be a subsequent frame to the image set 720a. Each image set may include a plurality of images, each captured at a respective position. These positions may be offset from one another, such that a combination of the plurality of images may provide depth information of the objects shown in the images. For example, each of the image set 720a and the image set 720b may include a pair of stereo images. The image set 720a may include a left image 722a and a right image 724a. The image set 720b may include a left image 722b and a right image 724b.

The sequence of image sets 720a, 720b may be provided to the trained machine learning model 104. The trained machine learning model 104 may be trained to compute a respective rotated disparity map 214 for each image set. The trained machine learning model 104 may be trained to identify features in images and further configured to determine spatial offset, also referred herein as disparity data, of the features between the images. The spatial offset between images of the same image set may provide depth information of the features. A rotation correction module 202 may compute a respective unrotated disparity map 216 for each rotated disparity map 214, for example, like described with respect to FIG. 4.

According to an embodiment which may be combined with any above-described embodiment or with any below described further embodiment, the device 700 may further include a point cloud generator 726. The point cloud generator 726 may include the 3D reconstruction module 206. The point cloud generator 726 may be configured to generate a 3D point cloud 208 based on the input 720 and the unrotated disparity map 216. The generated 3D point cloud 208 may be a 3D reconstruction of the environment that a vehicle is travelling in. As the 3D point cloud 250 may be generated in real-time, the device 100 may provide the vehicle with environmental data that is not previously available, for example, previously unmapped terrain. Further, the 3D point cloud 208 may indicate to the vehicle, the presence of dynamic objects such as other traffic participants. The 3D point cloud 208 may be generated further based on camera intrinsic parameters such as focal length along x,y camera principal point offset and axis skew. The point cloud generator 726 may also refine the 3D point cloud 208 to remove outliers and incorrect predictions, so that the 3D point cloud 208 may serve as an accurate dense 3D map. The point cloud generator 726 may remove the outliers and incorrect predictions based on probability of those data points.

Various aspects described with respect to the method 200 and the image processing method 600 may be applicable to the image processing device 700.

Collision prediction plays an important role in improving traffic safety. The majority of past research focused on determining time-to-collision (TTC) during the day when oncoming vehicles are visible. However, traffic accidents are more frequent at night since there is less visual information about vehicles and complex lighting conditions. At night, the visual feature information is almost reduced to the headlights and taillights of the vehicles. Traditional collision prediction systems rely on the vehicle's width and motion information, which is difficult to assess under poor lighting. Existing deep learning models trained for vehicle light recognition at night generally fail to generate reliable TTC values on pitch dark images. In advanced driver assistance systems, several algorithms rely solely on these features for vehicle detection. TTC is a commonly used safety metric, and it indicates the time it takes for a vehicle to collide with another vehicle.

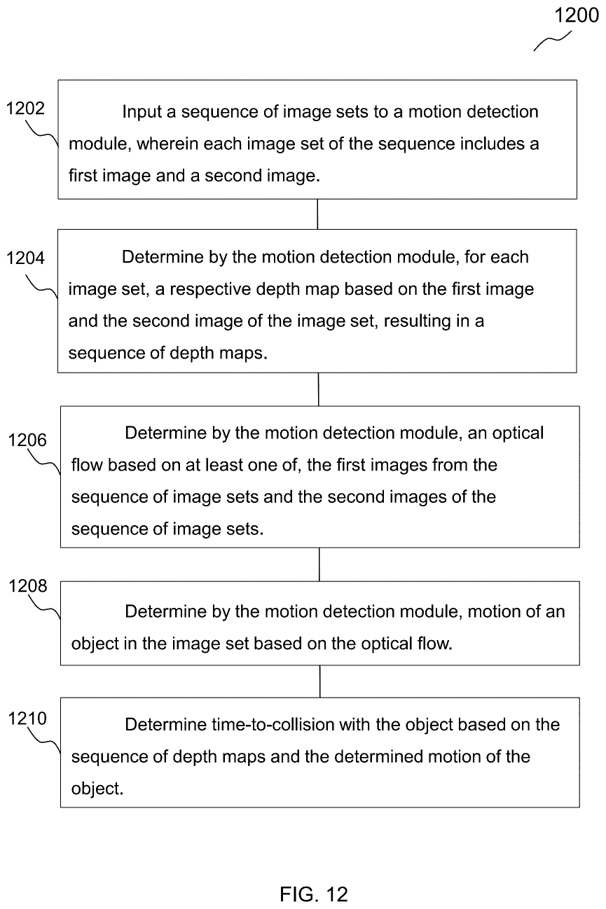

According to various embodiments, a computer-implemented method 1200 for predicting collisions is provided. The method 1200 may estimate TTC based on stereo disparity information and optical flow. The stereo disparity information may be obtained using the image processing method 600. The method 1200 is also described with respect to FIG. 12.

The method 1200 may include receiving a sequence of image sets. The sequence of image sets in the input 720 may be captured by sensors mounted on a vehicle. Examples of suitable sensors include stereo vision camera, thermal stereo camera, or dense LiDAR. LiDAR sensors may provide dense point cloud of the surrounding environment as well as the distance to each detected object in the scene. Each image set may include a plurality of images, and each image of the plurality of images may be captured from a different position on the vehicle, such that the plurality of images of each image set may have an offset in at least one axis, from one another. The plurality of images may be respectively captured by a corresponding plurality of sensors. The plurality of images may include a first image and a second image.

In an example, the sensor may be a pair of stereo cameras. As such, the image set includes a pair of stereo images. The two cameras may be separated by a baseline, the distance for which is assumed to be known accurately. The cameras may simultaneously capture two consecutive images. The images may be analyzed to identify differences between the images, and to identify the corresponding pixel-positions in both images, in a stereo matching process. The disparity between corresponding pixel in both images may be used to estimate depth. In an example, the pair of stereo cameras may be mounted on the side mirror of a vehicle. The stereo camera may be FSC231 stereo camera with 8.3M Pixel resolution and 30° field of view.

The method 1200 may include determining the disparity between the images in the image set, using a motion detection module that includes a machine learning model. The machine learning model may be, for example, the trained machine learning model 104. The machine learning model may include a neural network, such as graph neural network, transformers, or recurrent neural network. The machine learning model may include the neural network 1000 described with respect to FIG. 10. Using the estimated disparity, the distance and TTC for each given pixel or object in the scene captured by the images may be computed. The distance may be measured in meters, while the TTC may be measured in seconds. The features extracted for performing the stereo matching may be used to estimate TTC for each pixel in the image using deep neural network.

The method 1200 may include recognizing moving objects, by identifying moving pixels in the sequence of image sets. In other words, recognizing moving objects may involve finding corresponding pixels in the sequence of image sets, over time. Recognition of the moving objection may be accomplished by passing two consecutive stereo image pairs through an optical flow estimation algorithm.

The method 1200 may include combining the resulting flow information with the current stereo frame to segment moving objects in a scene, using a neural network. A point cloud generator may generate a 3D point cloud of the surrounding of the vehicle, based on the estimated depth, i.e. distance of each pixel.

According to various embodiments, the method 1200 may include providing stereo camera data to a motion detection module. The motion detection module may include a machine learning model, also referred herein as motion detection network. The motion detection network may include the trained machine learning model 104. The motion detection network may include, for example, a Convolutional Neural Network (CNN). The stereo camera data may include a first stereo image pair and a second stereo image pair. The first stereo image pair and the second stereo image pair may be captured successively. The motion detection network may be trained using stereo camera data, ground truth disparity and ground truth TTC values. The stereo camera data may be images captured at night, so that the motion detection network may learn to compute the disparity values and TTC values for night images. The motion detection network may also be trained with images associated with other environmental conditions such as day light, rain or snow. The motion detection network may be trained with uncalibrated stereo images, and may generate a rotated disparity map of the stereo camera data. The motion detection module may include a rotation correction module 202 that converts the rotated disparity map to unrotated disparity map. The motion detection network may perform stereo matching, by extracting feature information of left and right stereo images, and mapping each image to a dense disparity map. The motion detection network may be trained to determine the rotated disparity, the optical flow, and the TTC image output of two consecutive stereo image pairs. In order to segment moving objects in a scene, the flow information obtained may be combined with a current stereo frame to train the motion detection network to predict the mask of moving objects. The motion detection module may determine the relative depth of the moving objects based on the unrotated disparity map, and may further determine a TTC image based on the determined relative depth. The TTC image may include TTC values for each pixel in the image. The motion detection module may further perform trajectory planning based on the TTC estimation.

According to various embodiments, the disparity map, the input image and the flow information may be further used for estimating pose and performing simultaneous localization and mapping (SLAM) of the scene, for navigation of the vehicle.

FIG. 8A shows a simplified functional block diagram of a device 800 for predicting collisions according to various embodiments. The device 800 may be configured to receive an input 720 and may be configured to generate an output. The input 720 may include a sequence of image sets. The output may include predicted time-to-collision (TTC) 820 of a vehicle with another object or vehicle. The device 800 may be capable of determining the TTC 820 based on processing visual data, i.e. images. The device 800 may be configured to perform the method 1200.

The sequence of image sets in the input 720 may be captured by sensors mounted on a vehicle. Each image set may include a plurality of images, and each image of the plurality of images may be captured from a different position on the vehicle, such that the plurality of images of each image set may have an offset in at least one axis, from one another. The plurality of images may be respectively captured by a corresponding plurality of sensors. The plurality of images may include a first image and a second image. In some embodiments, the first image and the second image may be a pair of stereo images.

The device 800 may include a motion detection module 802. The motion detection module 802 may include a machine learning model, for example, the trained machine learning model 104. The motion detection module 802 may configured to generate a respective depth map 812 of each image set, based on the first image and the second image of the image set. Consequently, the motion detection module 802 may output a sequence of depth maps 812 based on the received sequence of image sets.

Each depth map 812 may be an image or image channel that contains information relating to the distance of the surfaces of objects from a viewpoint. The viewpoint may be a vehicle, or more specifically, a sensor mounted on the vehicle.

The motion detection module 802 may also be configured to determine an optical flow 814 based on at least one of, the first images from the sequence of image sets and the second images of the sequence of image sets. The motion detection module 802 may determine motion of an object in the image set based on the optical flow 814, to generate motion data 816.

The machine learning model in the motion detection module 802 may be used to determine both disparity and motion. The machine learning model may generate the segmented mask of moving objects based on the detected motion.

The device 800 may further include a prediction module 804. The prediction module 804 may be configured to receive the sequence of depth maps 812 and the motion data 816 from the motion detection module 802. The prediction module 804 may be configured to generate the predicted TTC 820 based on the received sequence of depth maps 812 and the motion data 816.

According to an embodiment which may be combined with any of the above-described embodiment or with any below described further embodiment, the motion detection module 802 may include the device 700. The motion detection module 802 may determine the depth maps 812 by generating a respective unrotated disparity map 216 for each image set, for example, according to the image processing method 600.

According to an embodiment which may be combined with any of the above-described embodiment or with any below described further embodiment, the device 800 may further include a point cloud generator 726 that generates a 3D point cloud 208 based on at least one image set of the sequence of image sets. The device 800 may be further configured to detect an object in the 3D point cloud 208.

According to an embodiment which may be combined with any of the above-described embodiment or with any below described further embodiment, the point cloud generator 726 may generate a respective 3D point cloud based on each image set of the sequence of image sets, resulting in a sequence of 3D point clouds 208. The device 800 may compare distances moved by each point in the sequence of 3D point clouds 208, and may correct at least one 3D point cloud of the sequence of 3D point clouds 208 based on the determined distances.

FIG. 8B shows a simplified hardware block diagram of the device 800 according to various embodiments. The device 800 may include at least one processor 830. The at least one processor 830 may be configured to carry out the functions of the machine learning model 802 and the prediction module 804.

According to various embodiments, the device 800 may be a driver assistance system.

According to various embodiments, the device 800 may be a vehicle.

According to an embodiment which may be combined with any above-described embodiment or with any below described further embodiment, the device 800 may further include a plurality of sensors 832. The plurality of sensors 832 may be configured to generate the sequence of image sets 816. The plurality of sensors 832 may include, for example, stereo cameras, surround view cameras, infrared cameras, event cameras, or dense LiDAR. The device 800 may include at least one memory 834. The at least one memory 834 may store the machine learning model 802 and the prediction module 804. The at least one memory 834 may include a non-transitory computer-readable medium. The at least one processor 830, the plurality of sensors 832 and the at least one memory 834 may be coupled to one another, for example, mechanically or electrically, via the coupling line 840.

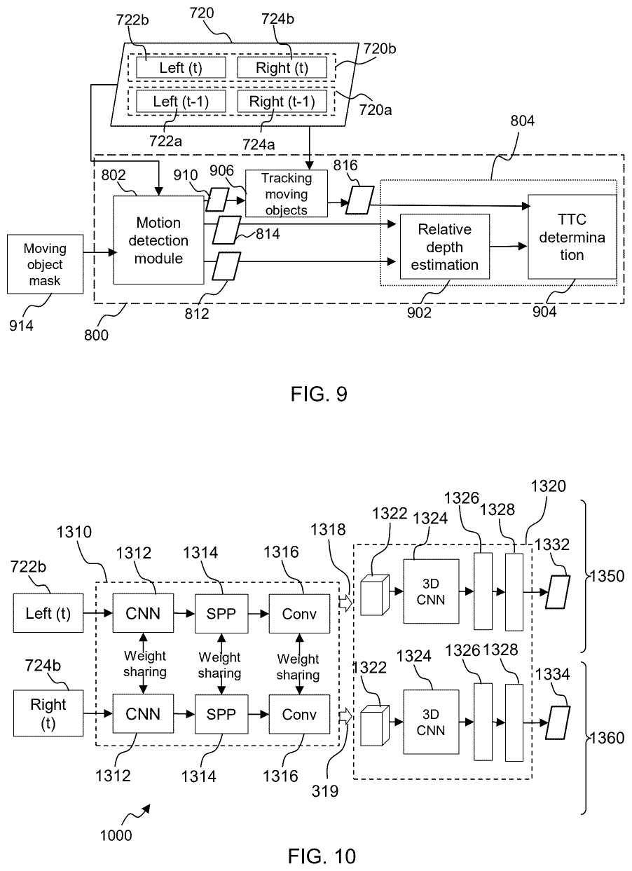

FIG. 9 shows a schematic diagram of the device 800 performing a method for predicting collisions, according to various embodiments. The motion detection module 802 of the device 800 may include a machine learning model that may generate a sequence of depth maps 812, optical flow 814 and motion data 816, based on a received sequence of image sets. The sequence of image sets may include at least a first image set 720a and a second image set 720b. Each of the image sets may include at least a first image and a second image, for example left image 722a and right image 724a of the first image set 720a, and the left image 722b and the right image 724b of the second image set 720b. The motion detection module 802 may also receive a moving object mask 914, which may be generated by another machine learning model.

The motion detection module 802 may output a segmented moving object image 910 based on the moving object mask 914 applied to the sequence of image sets. The device 800 may also include a tracking moving object module 906 configured to determine the motion data 816 based on the segmented moving object image 910.

The prediction module 804 of the device 800 may include a relative depth estimation module 902. The relative depth estimation module 902 may be configured to receive the sequence of depth maps 812, the optical flow 814 and the motion data 816. The relative depth estimation module 902 may determines relative depth of pixels in the images, based on the received inputs. The prediction module 804 may further include a TTC determination module 904. The TTC determination module 904 may determine the TTC of each pixel, based on the determined relative depth and the motion data 816.

FIG. 10 shows a schematic diagram of a neural network 1000 according to various embodiments. The neural network 1000 may be part of at least one of the trained machine learning model 104 and the motion detection module 802. The neural network 1000 may include a feature extraction network 1310 and a disparity computation network 1320. The feature extraction network 1310 may be configured to extract features from images in the sequence of image sets to generate feature maps. The disparity computation network 1320 may be configured to determine two-dimensional offsets (also referred herein as displacements or disparities) between the images based on the generated feature maps. The neural network 1000 may thereby determine both optical flow and depth information using a single common set of neural networks, as both the optical flow and depth information relate to two-dimensional offsets between images. As such, the neural network 1000 may be trained in a shorter time and with less resources, as compared to training two separate neural networks.

According to an embodiment which may be combined with any above-described embodiment or with any below described further embodiment, the neural network 1000 may be trained via supervised training, using scene flow stereo images. Training the neural network 1000 may require, for example, 25,000 scene flow stereo images as the training data. The neural network 1000 may be fine-tuned using stereo images from the Karlsruhe Institute of Technology and Toyota Technological Institute (KITTI) dataset. As an example, about 400 stereo images from the KITTI dataset may be used.

According to an embodiment which may be combined with any above-described embodiment or with any below described further embodiment, the feature extraction network 1310 may include a plurality of neural network branches. For example, the neural network branches may include a first branch 1350 and a second branch 1360. Each neural network branch may include a respective convolutional stack, and a pooling module connected to the convolutional stack. The convolutional stack may include, for example, the CNN 1312. The pooling module may include, for example, the SPP module 1314. The plurality of neural network branches may share the same weights. By having the neural network branches share the same weights, the feature extraction network 1310 may be trained in a shorter time and with less resources, than training the neural network branches individually.

According to an embodiment which may be combined with any above-described embodiment or with any below described further embodiment, the disparity computation network 1320 may include a 3D convolutional neural network (CNN) 1324 configured to generate three disparity maps based on the generated feature maps 1318. The feature extraction network 1310 may extract features at different levels. To aggregate the feature information along disparity dimension as well as spatial dimensions, the 3D CNN 1324 may be configured to perform cost volume regularization on the extracted features. The 3D CNN 11324 may include an encoder-decoder architecture including a plurality of 3D convolution and 3D deconvolution layers with intermediate supervision. The 3D CNN 324 may have a stacked hourglass architecture including three hourglasses, thereby producing three disparity outputs. The architecture of the 3D CNN 1324 may enable it to generate accurate disparity outputs and to predict the optical flow. The filter size in the 3D CNN 1324 may be 3*3.

According to an embodiment which may be combined with any above-described embodiment or with any below described further embodiment, the neural network 1000 may be configured to determine the respective depth map 812 of each image set based on the determined 2D offsets between the plurality of images of the image set. The depth map 812 may provide information on distance between objects in the images from the vehicle. This information may improve the localization accuracy. Each pixel in the depth map may be determined based on the following equation:

$$Depth = \frac{base l ine \times focal length}{d i s p a r i t y}$$

where baseline refers to the horizontal distance between the viewpoints that the images within the same image set were captured, focal length refers to distance between the lens and the image sensor, and disparity refers to the 2D offsets. The 2D offsets may be obtained from the unrotated disparity map 216.

According to an embodiment which may be combined with any above-described embodiment or with any below described further embodiment, the neural network 1000 may be configured to determine the optical flow 814, based on the determined 2D offsets between at least one of, the first images of adjacent image sets of and the second images of adjacent image sets. The optical flow 814 may provide information on the changes in position of objects in the images.

The neural network 1000 may be configured to perform a stereo matching operation. The stereo matching operation may include determining estimate a pixelwise displacement map between the input images. The input images may include a plurality of images of the same image set. For example, when the input contains images captured by a stereo camera, the input images may include a left image 722b and a right image 724b.

In general, stereo images may be rectified stereo images or unrectified stereo images. Rectified stereo images are stereo images where the displacement of each pixel is constrained to a horizontal line. The displacement map may be referred herein as disparity. To obtain rectified stereo images, the sensors or cameras used to capture the images need to be accurately calibrated.

Unrectified stereo images, on the other hand, may exhibit both vertical and horizontal disparity. Vertical disparity may be defined as the vertical displacement between corresponding pixels in the left and right images. Horizontal disparity may be defined as the horizontal displacement between corresponding pixels in the left and right images. It is challenging to obtain rectified stereo images from sensors mounted on a vehicle, as the sensors may shift or rotate in position over time, due to movement and vibrations of the vehicle. As such, the input images captured by the sensors mounted on the vehicle may be regarded as unrectified stereo images.

The neural network 1000 may be trained to be robust against rotation, shift, vibration and distortion of the input images. The neural network 1000 may be trained to handle both horizontal (x-disparity) and vertical (y-disparity) displacement. In other words, the neural network 1000 may be configured to determine both the horizontal and vertical disparity of the input images. This makes the neural network 1000 robust against vertical translation and rotation between cameras or sensors.

The neural network 1000 may have a dual-branch neural network architecture including a first branch 1350 and a second branch 1360, such that each branch may be configured to determine disparity in a respective axis. Each of the feature extract network 310 and the disparity computation network 1320 may include components of the first branch 350 and the second branch 360.

The feature extraction network 1310 may include a convolutional neural network (CNN) 1312, a spatial pyramid pooling (SPP) module 1314 and a convolution layer 1316, for each of the first branch 11350 and the second branch 1360. The CNN 1312 may extract feature information from the input images. The CNN 1312 may include three small convolution filters with kernel size (3×3) that are cascaded to construct a deeper network with the same receptive field. The CNN 1312 may include conv1_x, conv2_x, conv3_x, and conv4_x layers that form the basic residual blocks for learning the unitary feature extraction. For conv3_x and conv4_x, dilated convolution may be applied to further enlarge the receptive field. The output feature map size may be (¼×¼) of the input image size. The SPP module 1314 may be then applied to gather context information from the output feature map. The SPP module 1314 may learn the relationship between objects and its sub regions to incorporate hierarchical context information. The SPP module 1314 may include four fixed-size average pooling blocks of size 64×64, 32×32, 16×16, and 8×8. The convolution layer 1316 may be a 1×1 convolution layer for reducing feature dimension. The feature extraction network 1310 may up-sample the feature maps to the same size as the original feature map, using bilinear interpolation. The size of the original feature map may be ¼ of the input image size. The feature extraction network 1310 may concatenate the different levels of feature maps extracted by the various convolutional filters, as the left SPP feature map 1318 and the right SPP feature map 1319.

The disparity computation network 1320 may receive the left SPP feature map 1318 and the right SPP feature map 1319. The disparity computation network 1320 may concatenate the left and right SPP feature maps 1318, 1319 into separate cost volumes 1322 for x and y displacements respectively. Each cost volume may have 4 dimensions, namely, height×width×disparity×feature size. The disparity computation network 1320 may include a 3D-CNN 1322 in each branch. The 3D-CNN 1322 may include a stack hourglass (encoder-decoder) architecture that is configured to generate three disparity maps. The disparity computation network 1320 may further include an upsampling module 1326 and a regression module 1328, in each branch. The upsampling module 1326 may upsample the three disparity maps so that their resolution matches that of the input image size. The regression module 1328 may apply regression to the upsampled disparity maps, to calculate an output disparity map. The disparity computation network 1320 may calculate the probability of each disparity based on the predicted cost via SoftMax operation. The predicted disparity may be calculated as the sum of each disparity weighted by its probability. Next, smooth loss function may be applied between ground truth disparity and predicted disparity. The smooth loss function may measure how close the predictions are, to the ground truth disparity values. The smooth loss function may be a combination of 11 and 12 loss. It is used in deep neural network because of its robustness and low sensitivity to outliers. The disparity computation network 1320 then outputs the horizontal displacement 1332 at the first branch 1350, and outputs the vertical displacement 1334 at the second branch 1360. The machine learning model 102 may then determine a depth map 112 based on the horizontal displacement 1332 and the vertical displacement 1334, using known stereo computation methods such as semi global matching.

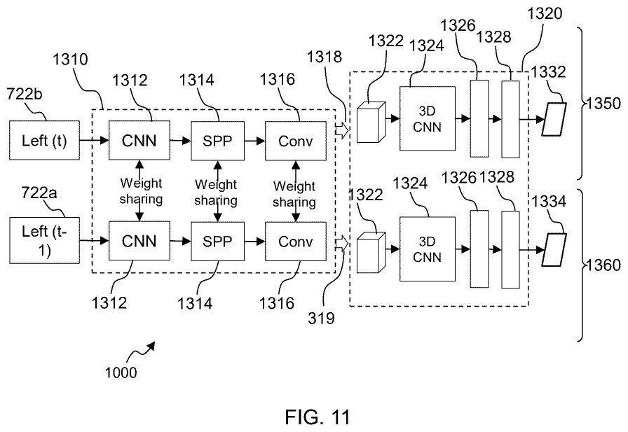

FIG. 11 shows a schematic diagram of the neural network 1000 according to various embodiments, receiving different inputs from those in FIG. 10. The neural network 1000 may also be configured to perform optical flow computation. The optical flow computation may include predicting a pixelwise displacement field, such that for every pixel in a frame, the neural network 1000 may estimate its corresponding pixel in the next frame. For the optical flow computation operation, the input images used by the neural network 1000 may be two successive images taken from the same position. In this example, the input images are left image 722b captured at time=t and left image 722a captured at time=t−1. The outputs of the neural network 1000 for the optical flow computation operation is the optical flow 814 that includes x-direction displacement and y-direction displacement.

The first branch 1350 may process the left image 722b, while the second branch 1360 may process the earlier left image 722a. Similar to the stereo-matching operation described with respect to FIG. 10, the optical flow computation operation may include extracting features using the CNN 1312 of the feature extraction network 1310. The SPP module 1314 may gather context information from the output feature map generated by the CNN 11312. The feature extraction network 1310 generate final SPP feature maps that are provided to the disparity computation network 1320. The difference from the stereo-matching operation, is that the SPP feature maps generated are an earlier SPP feature map (for time=t−1) and a subsequent SPP feature map (for time=t). The disparity computation network 1320 may concatenate the SPP feature maps into separate cost volumes 1322 for time=t−1 and time=t respectively. Each cost volume may have 4 dimensions, namely, height×width×disparity×feature size. The 3D-CNN 1322 of each branch may generate three disparity maps based on the respective cost volume 1322. The upsampling module 1326 may upsample the three disparity maps. The regression module 1328 may apply regression to the upsampled disparity maps, to calculate an output disparity map. The disparity computation network 1320 may calculate the probability of each disparity based on the predicted cost via SoftMax operation. The predicted disparity may be calculated as the sum of each disparity weighted by its probability. Next, smooth loss function may be applied between ground truth disparity and predicted disparity. The disparity computation network 320 then outputs the x-direction displacement and the y-direction displacement, that are determined to take place between time=t−1 to time=t.

According to various embodiments, suitable deep learning models for the machine learning model 102 may include, for example, PyramidStereoMatching and RAFTNet.

According to an embodiment which may be combined with any above-described embodiment or with any below described further embodiment, training of the neural network 1000 may, for example, be based on standard backpropagation based gradient descent. As an example how the neural network 1000 may be trained, a training dataset may be provided to the neural network 1000, and the following training processes may be carried out:

An example of a suitable training dataset for training the neural network 1000 may be the KITTI dataset.

Before training the neural network 1000, the weights may be randomly initialized to numbers between 0.01 and 0.1, while the biases may be randomly initialized to numbers between 0.1 and 0.9.

Subsequently, the first observations of the dataset may be loaded into the input layer of the neural network and the output value(s) is generated by forward-propagation of the input values of the input layers. Afterwards the following loss function may be used to calculate loss with the output value(s):

Mean Square Error (MSE):

$$M S E = \frac{1}{n} \sum {( y - \hat{y} )}^{2} ,$$

where n represents the number of neurons in the output layer and y represents the real output value and ŷ represents the predicted output. In other words, y−ŷ represents the difference between actual and predicted output.

The weights and biases may subsequently be updated by an AdamOptimizer with a learning rate of 0.001. Other parameters of the AdamOptimizer may be set to default values. For example:

$$beta\_ 1 = 0.9$$

$$beta\_ 2 = 0.9 \; 99$$

$$eps = 1 e - 08$$

$$weight\_decay = 0$$

The steps described above may be repeated with the next set of observations until all the observations are used for training. This may represent the first training epoch, and may be repeated until 10 epochs are done.

FIG. 12 shows a flow diagram of a computer-implemented method 1200 for predicting collisions, according to various embodiments. The method 1200 may include processes 1202, 1204, 1206, 1208 and 1210. The process 1202 may include inputting a sequence of image sets to a motion detection module, wherein each image set of the sequence comprises a first image and a second image. The sequence of image sets may include for example, the image sets 720a, 720b. The motion detection module may be for example, the motion detection module 802. The motion detection module may include the neural network 1000. The process 1204 may include determining by the motion detection module, for each image set, a respective depth map based on the first image and the second image of the image set, resulting in a sequence of depth maps. In an example, the image set may include a pair of stereo images, where the first image may be, for example, the left image 722a or 722b while the second image may be, for example, the right image 724a or 724b. The depth maps may include, for example, the depth maps 812. The process 1206 may include determining by the motion detection module, an optical flow based on at least one of, the first images from the sequence of image sets and the second images of the sequence of image sets. The optical flow may be for example, the optical flow 814. The process 1208 may include determining by the motion detection module, motion of an object in the image set based on the optical flow. The process 1210 may include determining TTC with the object based on the sequence of depth maps and the determined motion of the object. The method 1200 may be able to determine TTC using camera images, even when the road lighting is dim. As such, employing the method 1200 on vehicles, may result in avoidance of traffic accidents at night. Various aspects described with respect to the device 800 may be applicable to the method 1200.

According to an embodiment which may be combined with any above-described embodiment or with any below described further embodiment, the process 1204 may include generating a respective unrotated disparity map for each image set using the image processing method 600, and determining the respective depth map based on the respective unrotated disparity map. Determining the depth maps using unrotated disparity maps generated according to the image processing method 600 allows accurate depth to be determined even when the cameras that output the images in the image sets are uncalibrated. The uncalibration of the cameras may occur as a result of vibrations or movements of the vehicle on which the cameras are mounted.

According to an embodiment which may be combined with any above-described embodiment or with any below described further embodiment, the method 1200 may further include generating a 3D point cloud based on at least one image set of the sequence of image sets, and detecting the object in the three-dimensional point cloud. The 3D point cloud is a dense in data. The 3D point cloud provides detailed information of the surroundings of the vehicle, such that object detection in the 3D point cloud is accurate.

According to an embodiment which may be combined with any above-described embodiment or with any below described further embodiment, the method 1200 may further include generating a respective three-dimensional point cloud based on each image set of the sequence of image sets, resulting in a sequence of three-dimensional point clouds, comparing distances moved by each point in the sequence of three-dimensional point clouds, and correcting at least one three-dimensional point cloud of the sequence of three-dimensional point clouds, based on the determined distances. By comparing the distances moved by each point, the method 1200 may correct for distortions caused by, for example, camera intrinsics or extrinsics.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1. A computer-implemented image processing method comprising:
inputting an image set to a trained machine learning model, the image set comprising a first image and a second image;
generating a rotated disparity map of the image set, using the trained machine learning model;
for each pixel in the first image,
determining, based on the rotated disparity map, a rotation angle between the pixel in the first image and its corresponding position in the second image, relative to a common image centre, and
determining a respective unrotated disparity based on the respective rotation angle; and
generating an unrotated disparity map based on the respective unrotated disparity of each pixel in the first image.

2. The image processing method of claim 1, wherein the image set comprises stereo images, wherein the first image is a left stereo image and wherein the second image is a right stereo image.

3. The image processing method of claim 1, wherein the trained machine learning model is configured to determine both horizontal disparities and vertical disparities of the image set, such that the rotated disparity map comprises both horizontal disparities and vertical disparities.

4. The image processing method of claim 1, wherein a center of the first image is used as the common image center.

5. The image processing method of claim 1, further comprising:
segmenting the first image into a plurality of first regions;
segmenting the second image into a plurality of second regions corresponding to the plurality of first regions;
determining for each first region of the plurality of first regions an epipolar line and its direction based on a pixel in the first image and its corresponding position in the second image.

6. The image processing method of claim 5, further comprising:
determining for each pixel of the first image a respective horizontal disparity based on projection of the respective unrotated disparity through the direction of the epipolar line.

7. The image processing method of claim 1, further comprising:
generating a three-dimensional point cloud based on the image set and the unrotated disparity map.

8. The image processing method of claim 7, further comprising:
inputting a further image set to the trained machine learning model, the further image set comprising a further first image and a further second image captured at a consecutive time frame from the first image and the second image of the image set;
generating a further rotated disparity map of the further image set, using the trained machine learning model,
for each pixel in the further first image,
identifying a corresponding pixel in the further second image based on the further rotated disparity map, and
determining a respective rotation angle between the pixel in the further first image and the corresponding pixel in the further second image, relative to a further common image centre, and
determining a respective unrotated disparity based on the respective rotation angle;
generating a further unrotated disparity map based on the respective unrotated disparities of each pixel in the further first image;
generating a further three-dimensional point cloud based on the further image set and further based on the further unrotated disparity map;
determine a distance that each point in the three-dimensional point cloud moves from the three-dimensional point cloud to the further three-dimensional point cloud; and
correcting at least one of the three-dimensional point cloud and the further three-dimensional point cloud, based on the determined distances.

9. The image processing method of claim 1, wherein the trained machine learning model is trained using a training dataset comprising a plurality of image pairs generated by rotating a pair of calibrated images to a corresponding plurality of different angles, and using a ground truth disparity map generated based on the pair of calibrated images as a training signal.

10. The image processing method of claim 1, further comprising:
training the machine learning model to determine near range disparities, and
training the machine learning model to determine far range disparities.

11. The image processing method of claim 1, wherein the trained machine learning model comprises
a feature extraction network configured to extract features from the image set to generate a feature map, and
wherein the trained machine learning model further comprises a disparity computation network configured to determine the rotated disparity map based on the generated feature map.

12. The image processing method of claim 11, wherein the feature extraction network comprises a plurality of neural network branches, wherein each neural network branch comprises a respective convolutional stack, and a pooling module connected to the convolutional stack, and wherein the plurality of neural network branches share the same weights.

13. The image processing method of claim 11, wherein the disparity computation network comprises a three-dimensional convolutional neural network configured to generate three disparity maps based on the generated feature map.

14. An image processing device comprising:
a processor configured to perform an image processing method comprising
inputting an image set to a trained machine learning model, the image set comprising a first image and a second image,
generating a rotated disparity map of the image set, using the trained machine learning model,
for each pixel in the first image,
determining, based on the rotated disparity map, a rotation angle between the pixel in the first image and its corresponding position in the second image, relative to a common image centre, and
determining a respective unrotated disparity based on the respective rotation angle, and
generating an unrotated disparity map based on the respective unrotated disparity of each pixel in the first image.

15. The image processing device of claim 14, further comprising:
a camera;
an engine for driving the image processing device; and/or a steering module for steering the image processing device,
wherein the processor is configured to use the unrotated disparity maps for at least one of driving and steering the image processing device.

16. The image processing device of claim 14, wherein the processor is further configured to generate a three-dimensional point cloud based on the image set and further based on the unrotated disparity map.

17. A computer-implemented method for predicting collisions, the method comprising:
inputting a sequence of image sets to a motion detection module, wherein each image set of the sequence comprises a first image and a second image;
determining by the motion detection module, for each image set, a respective depth map based on the first image and the second image of the image set, resulting in a sequence of depth maps;
determining by the motion detection module, an optical flow based on at least one of, the first images from the sequence of image sets and the second images of the sequence of image sets; and
determining by the motion detection module, motion of an object in the image set based on the optical flow; and
determining time-to-collision with the object based on the sequence of depth maps and the determined motion of the object.

18. The method of claim 17, wherein determining the respective depth map for each image set comprises:
generating a respective unrotated disparity map for each image set further comprising:
inputting the image set to the trained machine learning model;
generating a rotated disparity map of the image set, using the trained machine learning model;
determining, based on the rotated disparity map, for each pixel in the first image a rotation angle between the pixel in the first image and its corresponding position in the second image, relative to a common image center;
determining for each pixel in the first image a respective unrotated disparity based on the respective rotation angle; and
generating an unrotated disparity map based on the respective unrotated disparity of each pixel in the first image; and
determining the respective depth map based on the respective unrotated disparity map.

19. The method of claim 17, further comprising:
generating a three-dimensional point cloud based on at least one image set of the sequence of image sets; and
detecting the object in the three-dimensional point cloud.

20. The method claim 19, further comprising:
generating a respective three-dimensional point cloud based on each image set of the sequence of image sets, resulting in a sequence of three-dimensional point clouds;
comparing distances moved by each point in the sequence of three-dimensional point clouds; and
correcting at least one three-dimensional point cloud of the sequence of three-dimensional point clouds, based on the determined distances.
